(19) United States
(12) Patent Application Publication
(10) Pub. No.: US 2002/0166220 A1
(43) Pub. Date: Nov. 14, 2002

(54) Process for repairing a structure

(75) Inventors: Michael L. Imundo, Plainfield, IN (US); John R. Dailidonis, Indianapolis, IN (US)

Correspondence Address: BRINKS HOFER GILSON & LIONE, P.O. Box 10395, Chicago, IL, 60610, US

(73) Assignee: United Air Lines, Inc.

(21) Appl. No.: 09/853,945

(22) Filed: May 11, 2001

(51) Int. Cl. B23P 6/00

(52) U.S. Cl. 29/402.09

(57) ABSTRACT

A method for repairing structures uses an accurate measurement of the part to be repaired and the structure into which it fits. The method allows for a digital measurement of features of the part and the structure, and eliminates tedious and inaccurate hand-measurement methods previously used. The method is primarily applicable to one-of a-kind parts requiring exact measurements, because of the unique shape that a part may assume when it is subject to stress and strain over time and many cycles of use.

### BACKGROUND OF THE INVENTION

Large structures and machines are frequently made from many parts and components. These structures include but are not limited to aircraft, ships, machines and buildings. In many of these structures, there are large components subject to such vicissitudes of time as wear, fatigue, corrosion, stress, and strain. When such a component must be replaced, the process can be very costly and time-consuming. The structure has “worn-in,” and some of the components have become distorted from their as-manufactured or as-installed condition. These changes mean that a part from the manufacturer, as originally designed and manufactured, may no longer fit precisely into the structure. A user may have some difficulty using a replacement part from the manufacturer, even if it is forced into place.

The differences between similar parts may be small as a percentage of the length or girth of the part, but may be large enough to present difficulties upon assembly. The situation may then be exaggerated as structures “wear in” and absorb stress over time. Plastic deformation and strain may result in considerable differences between a part as installed and a part after several years' service. As a result, dimensional data or drawings from a manufacturer of the part may not be consistent with the needs of the end-item owner after several years. In other words, parts made by the manufacturer from design and manufacturing data may not fit into individual structures or end-items. These structures are not limited to aircraft, but may include ships, portions of buildings or other civil structures, submarines, large machines, and the like.

One way around this difficulty is to hand-fit a replacement part, tailor made to fit exactly into place. Such hand-fitting may be accomplished by custom manufacturing, using templates and detailed labor to replicate the actual needed fit. In one such hand-fitting, thin sheets of hard plastic are laid over the structure in need of repair, and marked, trimmed and drilled to replicate exactly the old part. Besides being very costly and time-consuming, such methods are prone to error. Thus, a feature not placed correctly or a hole placed too near an edge may result in a ruined replacement part. A feature may be any real or imaginary portion or location on a structure, such as a hole, a length, a boss, a rib, an edge or a datum.

### BRIEF SUMMARY OF THE INVENTION

The invention is a method for repairing a structure or a portion of a structure. The method includes setting up a measuring device to measure the part or portion to be repaired. The device is desirably a multi-axis measuring machine, having linear axes or rotary axes of motion. In one sense, the measuring device may be very similar to a coordinate measuring machine (CMM) or a computer numerically-controlled (CNC) machining center, in that it desirably possesses a plurality of axes with which it may quickly and efficiently measure the desired features and contours of the device or portion requiring repair. The device is set-up and oriented so that the measuring device may measure and digitize data for the portion to be repaired with respect to the structure of which it is a part.

The device then measures the appropriate portion and stores the data in a convenient format. The data may be saved to an internal drive or storage medium, such as a hard drive or a disc, or it may be immediately transferred to an external drive or storage medium, or even another computer. The data is then used to program at least one machine tool and automatically manufacture the needed repair part. The method will work for parts in three dimensions, that is, parts requiring a length, width and depth, or parts in three dimensions that may be more conveniently measured in spherical or cylindrical coordinate systems rather than linear (Cartesian) systems. The part may then be installed.

In another method of practicing the invention, the portion of a structure requiring repair is a sheetmetal or two-dimensional part, such as a bulkhead of an aircraft or a ship. The measuring device is set up and oriented near the bulkhead. The device then measures the portion to be repaired and saves the data. The data is then used to automatically manufacture a sheetmetal repair part, the data driving one or more tools on a machine tool working the sheetmetal repair part. The repair part is then installed on the structure requiring repair.

### BRIEF DESCRIPTION OF SEVERAL VIEWS OF THE DRAWINGS

FIG. 1 depicts an exemplary aircraft structure in need of repair.

FIG. 2 is a magnified view of an area where a bulkhead has been removed and must be replaced.

FIG. 3 is a mount suitable for use in measuring a structure.

FIG. 4 depicts a measuring machine suitable for measuring a structure.

FIG. 5 describes a process for repairing a structure

FIG. 6 depicts an operator using a measuring machine to orient the measuring machine with the area in need of repair.

FIG. 7 depicts an operator using a measuring machine to orient the measuring machine with the structure.

FIG. 8 depicts an operator using a measuring machine to measure the periphery of a portion in need of repair.

FIG. 9 depicts a nesting sequence of parts required for the repair.

FIG. 10 depicts a replacement part being machined in an operation on a CNC router.

FIG. 11 depicts a replacement part being formed in another operation.

### DETAILED DESCRIPTION OF THE INVENTION

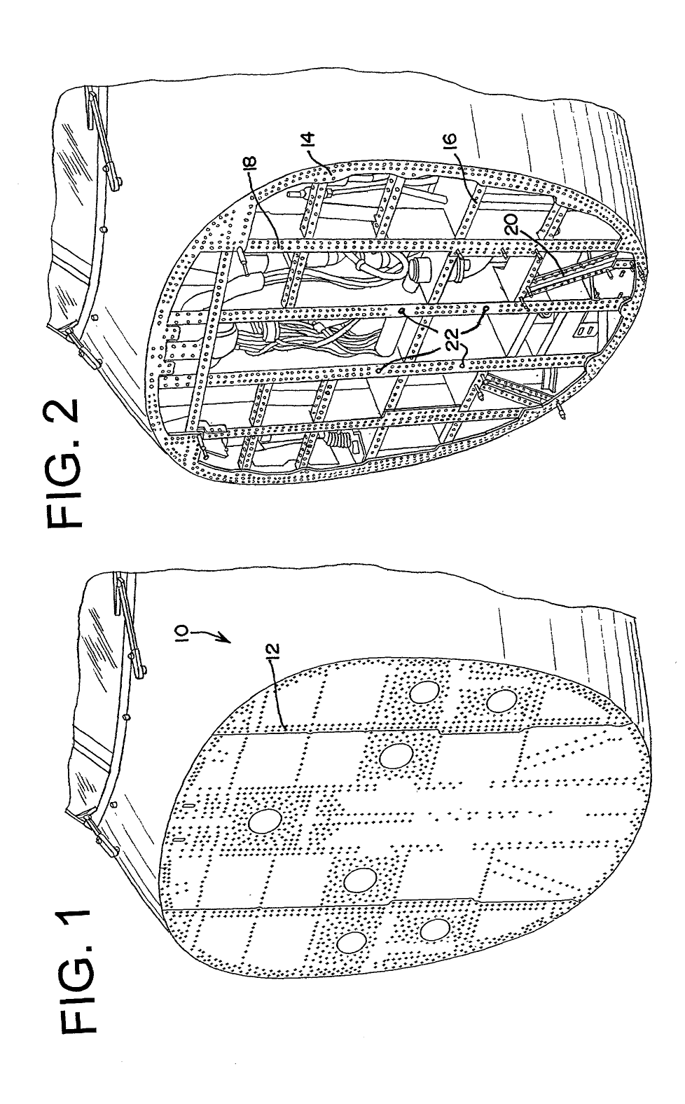

FIG. 1 depicts an aircraft 10 having a bulkhead 12 in need of repair. In this depiction, the bulkhead area is forward on the aircraft and a radome (not shown) has been removed so that repair technicians and mechanics may remove the bulkhead. It will be appreciated that in many cases, such parts bear similarity to parts on other aircraft, for instance other aircraft of the same type and model made by the same manufacturer. While the parts may be very similar, however, each individual aircraft's parts may be slightly different, especially in very large structures. In other words, there may be small differences on each particular aircraft, structure, machine, or building, the differences arising at their inception or later, even though each is nominally the same as all others of the same make, model, type or class.

FIG. 2 depicts an area of the aircraft where a replacement bulkhead is needed, and shows the underlying structure into which the bulkhead must fit. The bulkhead manufactured must match the periphery 14 and bolt up with horizontal members 16 such as stringers and T-bars, vertical members 18, and reinforcing members 20. In matching a part to these elements, it is also important to note the position of aircraft alignment holes 22, features with a known location and orientation. It is this area into which the replacement part must fit, and whose dimensions may have changed over time and over use.

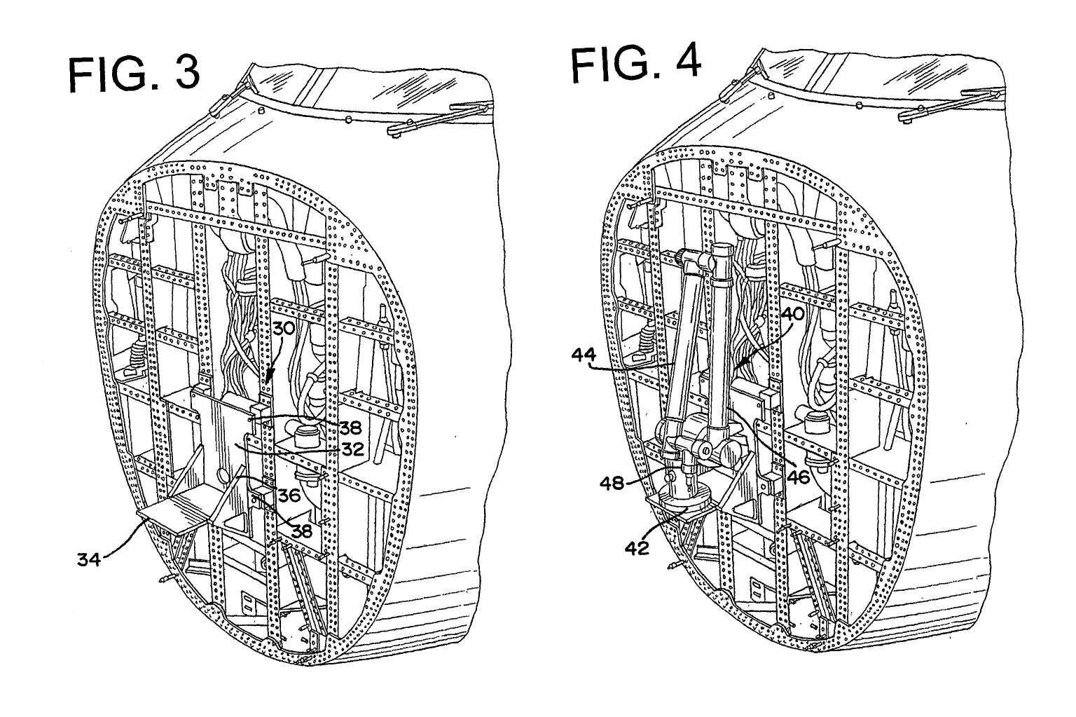

FIG. 3 depicts a mounting bracket useful for mounting a measuring device in proximity to the area where measurements are needed. The mounting bracket 30 has a vertical member 32 for mounting to the structure via pads 38. Gussets 36 may support a horizontal member 34 in order to mount a measuring device. Such a measuring device is depicted in FIG. 4. The measuring device may be a multi-axis coordinate measuring machine 40, having a base 42 and at least one linear axis 44, and preferably having at least one rotary axis 46, and a probe 48. A preferred device, available from Faro Corp., Lake May, Fla., is a model Faro Gold Arm measuring device. It has 6 axes of motion, three linear and three rotary. The measuring device is mounted on the bracket and oriented with plumb lines in at least one plane. Plumb bobs are suitable for this orientation.

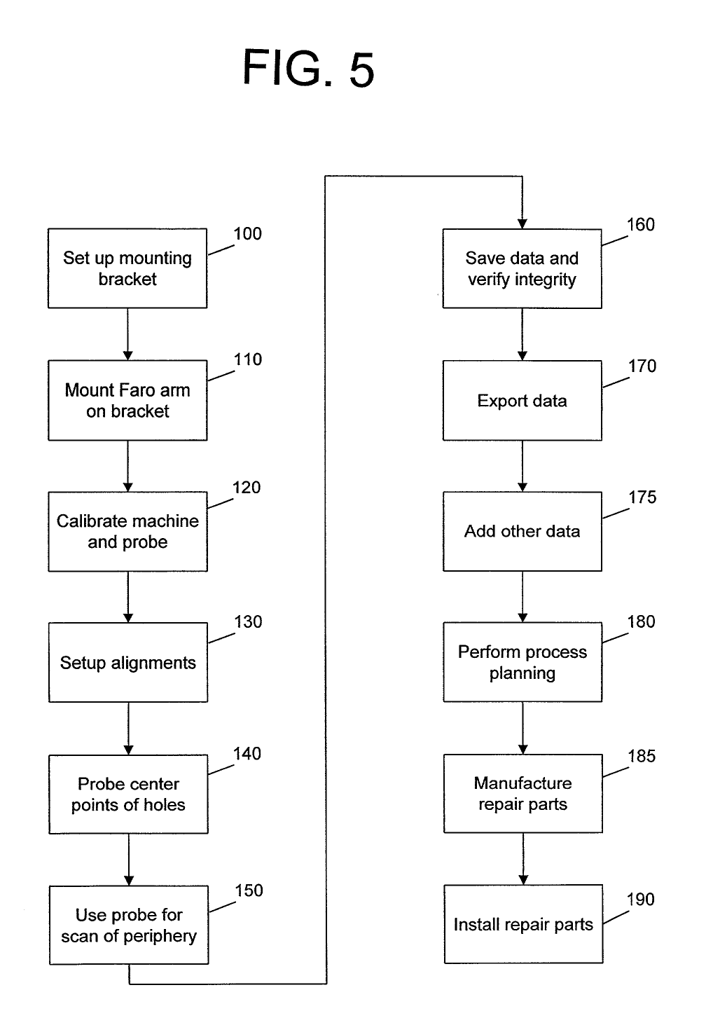

In accordance with the present invention, FIG. 5 describes a process for repairing a structure using a measuring device such as the Faro arm. In this embodiment, a user sets up a mounting bracket for the measuring device 100, as near as convenient to the structure needing repair. The use then mounts the Faro arm on the bracket 110. In one embodiment, the user then turns on the machine, installs the probe, and calibrates the machine and probe 120. Probes may be tangible objects, such as a standard Renishaw probe for a coordinate measuring machine (CMM), or they may consist of laser probes, using a light beam rather than a physical touching of the object being measured. The user than aligns the machine and probe 130 with respect to the structure being repaired.

With the measuring device oriented with respect to the structure, the measuring process may be performed, measuring features and storing the data in a computer or peripheral memory. The user manipulates the probe to measure all features needed for reproducing the part needing repair, such as the center points of holes 140, and their other necessary dimensions. It may be necessary to guide the probe around the periphery or boundaries of a part 150 if the part is not readily described in geometrical terms, or if the part has “settled in” sufficiently to require customizing. Once all measurements are taken, the user gathers the saved data and may perform sufficient tests to guarantee its integrity 160. The file or data are then exported from the measuring machine 170 to begin manufacturing a part. In some cases, other data, such as features not requiring measuring, may be added 175. The data is preferably available from one or more computer programs or files available to the user. In some cases, process planning for conventional manufacturing processes 180 will be necessary. Process plans or manufacturing instructions are prepared and the repair parts are manufactured 185. The repair parts are then installed 190.

In one embodiment of the process, reference features for orienting the measuring device are provided on the structure itself. For example, in the Boeing 737, the station 178 bulkhead has two orienting rivet holes just forward of the bulkhead and on the bottom skin of the aircraft to orient the user. Other structures may use other data (datums) or points for orientation. In the case of a bulkhead in need of repair, the bulkhead having a largely planar structure, the plane of the bulkhead bottom may be defined by recording reference points with the measuring device. The subject of orientation of measuring devices is well known to those is mensuration arts and will not be repeated here.

It is not strictly necessary for the method to use a mount and a measuring machine mounted as shown in FIGS. 3 and 4. Any automatic measuring technique may be used; however, a relatively small and mobile measuring machine is convenient and quick. A user may also use variations of the method, however, such as moving the part or structure to a CMM or moving a CMM conveniently near the structure.

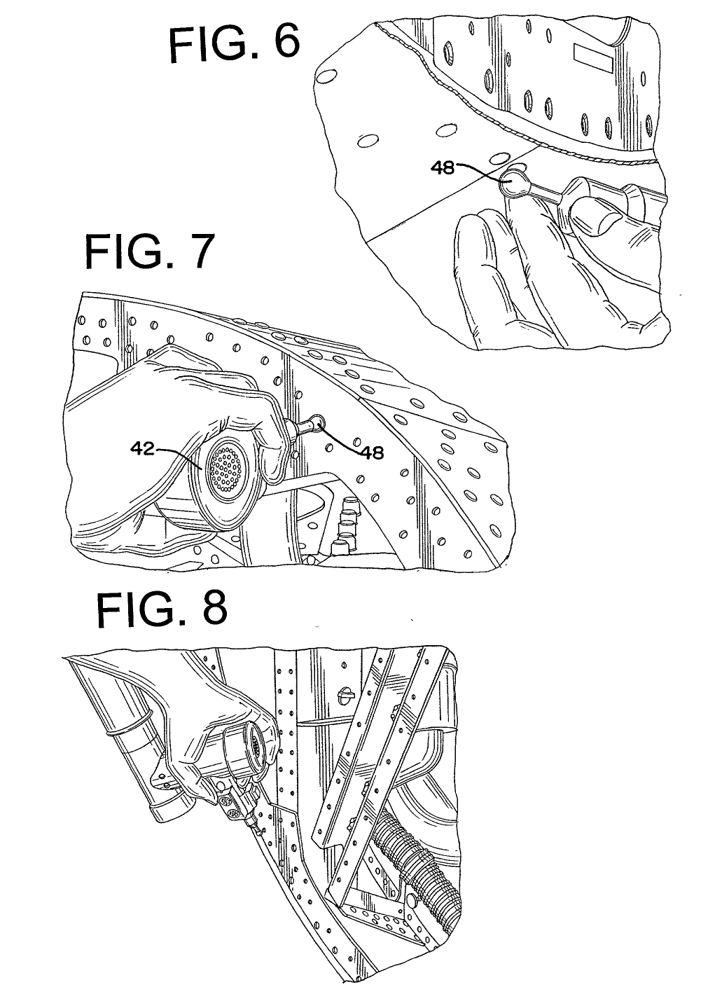

FIG. 6 depicts an operator manipulating the measuring device and its probe 48 to measure the alignment holes and record their location. FIG. 7 depicts a user manipulating an axis 42 of the measuring device and the probe 48 to take reference points establishing the plane of the bulkhead. Exemplary of probes are those made by Renishaw plc of Gloucestershire, United Kingdom.

Once the measuring device is oriented, a user may then begin the measuring process. FIG. 8 depicts an operator manipulating the measuring device to scan in the periphery of the bulkhead. Every other feature desired may also be measured and scanned in. Not every feature of the replacement part need be so measured or scanned. In the present example, the replacement bulkhead must have holes drilled to match every hole in the underlying structure where a fastener is desired. Other features may include, but are not limited to, cut-outs, pockets, slots, and chamfers. Even a relatively planar bulkhead may require fasteners, and thus holes, drilled at an angle. The measuring process may take all data in three dimensions using every axis available on the measuring device. For example, every hole may be measured using its diameter or radius, the angle desired with the surface of the bulkhead (if not perpendicular), and even the depth of the hole, such as for a blind hole that must be drilled and tapped later. Chamfers and lead-ins may also be measured if needed.

While a measuring arm and a probe are useful for measuring the structure and gathering data, other means may be used. Another apparatus that has been found useful is a laser scanner used with special software. With this device, dimensions are measured quickly and easily, and the data is recorded for later use. Equipment and software useful for this purpose is available from NVision, Inc., of Dallas, Tex. A laser scanner allows a user to take the application from a part requiring repair to a machine tool or other implement capable of making a repair part. Such machine tools may include multi-axis machining centers, including but not limited to, 3-, 4-, 5- and 6-axis machining centers. Laser scanners reduce the time needed to scan in the data from a part or a structure, particularly when the part requiring repair is large, or when the part is complex, especially in terms of dimensional complexities such as compound curvatures and the like. In some instances, a laser scanner may be able to access areas of structures better than a probe.

In using such a laser-scanning device, a process for repairing a structure includes mounting the device, preferably on a multi-axis coordinate measuring machine. The device is then oriented, and the part to be repaired is measured. The data is then saved and used to manufacture a repair part.

Preferably, data is taken with consideration of the processes to be used for manufacturing the repair parts. If the bulkhead has a flange or other portion in a third dimension, the flange must also be measured. While it is convenient to think of the measuring and subsequent machining processes in two dimensions, the method is not so limited. Parts may be manufactured in three dimensions using normal metal-working or other material-working machines to shape and form the parts as desired. Thus, a flange may be added to otherwise flat sheetmetal by designing in the required bend and using a press brake. Other forming processes may also be used, including machining techniques, or molding or forming techniques better suited to non-metallic materials, such as composites, reinforced composites, thermoplastics and thermoset plastic materials.

It is not necessary that the measuring device measure every feature of the repair part. In the example given, the bulkhead may be secured to the underlying structure by a number of fasteners through holes in the bulkhead. Because of dimensional change over time, these holes must be measured. However, other holes in the bulkhead may not need to be measured. For instance, reinforcing panels, doublers, and other components may be fastened to a main portion of the bulkhead with some fasteners but not to the aircraft by other fasteners. There is thus no reason to measure these particular holes precisely, since they were not subject to movement and may be placed wherever convenience and design rules allow, such as the holes placed in the original design and manufacture. Thus, another aspect of the method is adding additional manufacturing data to the measured data.

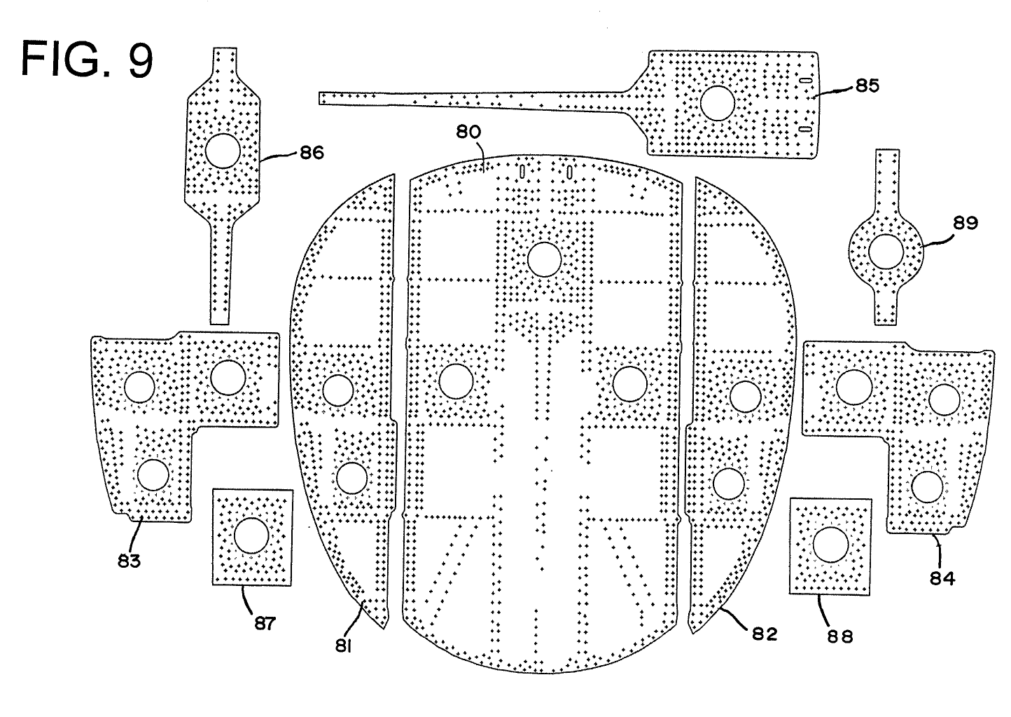

The situation may be as depicted in FIG. 9, in which a bulkhead repair is being planned. Manufacturing and installing the panels depicted in the figure will repair the bulkhead. The largest structure 80 may be smaller than the desired bulkhead because of material, machinery, or manufacturing limitations. Therefore, side panels 81 and 82 augment panel 80. Several other doublers 83, 84, 85 and triplers 86, 87, 88, 89 are also needed for the repair. In order to manufacture the parts, it may have been necessary to measure the periphery of the bulkhead, which periphery will include the edges of parts 80, 81, 82, 83 and 84 in this example. Some of the circular cutouts may be stable and not require measurement, some may require measuring. If the placement of the cutouts is important for some function, then it may be prudent to include them in the measuring portion of the process.

Holes used by fasteners to secure the bulkhead to the underlying structure should be measured according to the process. Data for holes needed only to secure doublers or reinforcing panels may possibly be imported from the original equipment manufacturer or other source acceptable to any warrantor or regulator of the equipment. These may include the equipment manufacturer or builder, and may include regulatory authorities responsible for regulating the use of the equipment. If a portion or a feature of the structure is such that it did not require custom manufacturing or fitting, and its dimensions are known, it may not be necessary to measure the part before cutting its replacement. In such cases, data for these features may be imported from another source and used instead.

Note that the method may allow the measured bulkhead shown in FIG. 2 to be fabricated by directly making the detailed parts depicted in FIG. 9. The method will provide for the measuring and digitization of the feature data for the features shown in FIG. 2. If the part is small enough, if material is available, and if a single machine large enough to manufacture the part is available, then further process planning may not be needed. In many instances, however, it is the large size that gives rise to the difficulty of fitting up such a repair part, and a number of pieces will be needed, not merely one piece. In those instances, a process planning step allows for the transformation from the data gathering portion of the method to the manufacture of the parts.

In process planning, a user converts the measured data into a usable format. The user may also convert the data into several contiguous parts for ease of manufacturing and assembly, rather than a single part. The user may refer to the original equipment manufacturer's design as part of the repair process, for instance, to define parts and split the repairs into a number of parts, as shown in FIG. 9. Process planning may be performed automatically on some parts, but typically is done by process engineers or planners. After splitting a repair structure into a number of discrete pieces, the planner may then use the gathered and digitized data to generate process plans and programs for each part. If more than one manufacturing step is involved, each part may have a number of operations, set-ups, programs and machines for its manufacture.

Even for a simple part, process planning may be involved in order to speed-up manufacturing and make it more efficient. For instance, if the fastener holes to be drilled are of more than one size, each size may be placed on a different layer in a computer-aided manufacturing (CAM) program, such as AutoCAD® or Mastercam® or CATIA®. AutoCAD® is a product of AutoDesk®, Inc., San Rafael, Calif. Mastercam® is a product of CNC Software, Inc., Tolland Conn. CATIA® is a product of Dassault Systemes, Paris, France, and is represented in the United States by IBM. When the part is manufactured, a machine tool may then drill all holes having the same diameter in a single operation with a single tool before proceeding to another operation. Manufacturers will perform these and other process practices well known to those skilled in manufacturing arts.

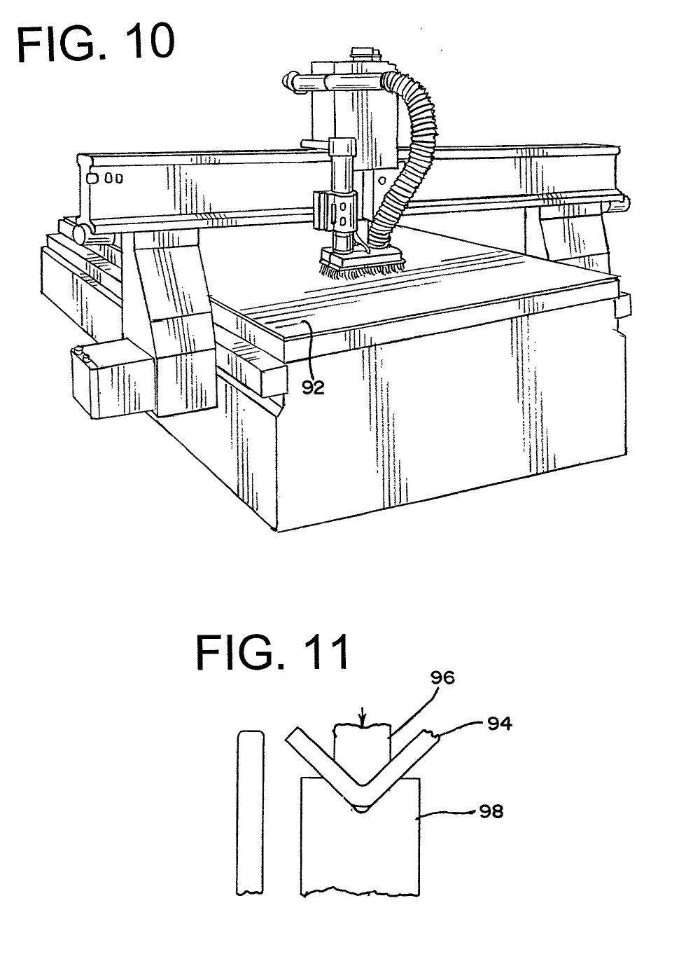

FIG. 10 depicts a panel 92 being drilled on a CNC router according to information on the dimensions of the panel, the information gathered through the measuring process and other data available to the organization making the repair parts. FIG. 11 depicts a panel 94 being formed on a press brake by a punch 96 and die 98. Whatever the repair part desired, the process must be governed by process engineering in order to achieve economical and timely repair parts, considering that most production under this method will be limited to a lot size of one. While drilling and forming processes have been depicted, the process is not limited to these, and other precision parts may also be made. Other processes may include, but are not limited to, forming, blanking, routing, tapping, turning, milling, and grinding.

A user may use a variety of technologies to capture the data from the part requiring repair. Any method suitable for use in a computer-aided design/computer-aided manufacturing (CAD/CAM) environment is acceptable. In one method of practicing the invention, a measuring device from Faro uses SAP software to capture the measuring data in the form of a solid model. Other measuring devices may use software from VDA or other source. It is convenient if the data, in whatever format, may be exported from the measuring device and its memory as an IGES (initial graphics exchange specification) file. In one embodiment, the measured data is imported as an IGES file into a Mastercam® program. A process engineer then programs one or more machines to manufacture the parts automatically. In another embodiment, the measuring device is programmed in AutoCAD® or other program directly suitable for CAM or for which a translator is available. The data may then be manipulated, for instance to check its integrity and its reasonableness, as well as to add other data as mentioned above. Any perceived errors may be corrected at this stage as well. Other data or features desired may be added here as well, whether by a programmer or designer, or by importing another data file.

The file or files may then be prepared for computer-aided manufacturing. The data may be split into separate parts, as shown for instance, in FIG. 9, deleting in a given file all sections not required for a given part. In the case of sheetmetal or other flat parts, it may also be convenient to nest the parts in order to conserve material. A program called TruNest™ has been found very useful for process planning in this step. TruNEST™ is a product of Magestic Systems, Inc., Old Tappan, N.J. Process engineering for flat or sheetmetal parts is fairly straightforward. Process planning for other parts calls for the normal process engineering functions. Once the operations have been broken down into setups and stations, machining or manufacturing may proceed automatically in a normal computer-aided manufacturing, NC or CNC environment. Once a file has been prepared for CAM, the file may be exported to an NC (numerical control) or CNC (computer numerical control) machine for manufacture of the part.

While this invention has been shown and described in connection with the preferred embodiments, it is apparent that certain changes and modifications, in addition to those mentioned above, may be made from the basic features of this invention. For example, aircraft parts have been featured, but the method is not limited to aircraft parts. The method may apply to any structure having parts or components in need of repair. These may include, but are not limited to, large machines or structures, for instance ships, buildings, locomotives, machinery, draglines, process-equipment vessels or reactors, large machine tools, bridges and dams. While measuring machines from Faro Technologies have been mentioned, any suitable digital measuring machine may be suitable, including those made by Boice, Brown & Sharp, Mitotoyo, Numerex, Sheffield, Zeiss and others.

Because of the importance of not causing damage to structures such as aircraft, it is prudent to use an operator to hand-guide a CMM axis as it approaches a measurement point; however, the invention will work with a conventional-coded CMM given multiple points to approach and inspect. The invention has been described in terms of a structure's strains and departures from its as-manufactured state; however, original manufacturing and inspection data may be used as a starting point for each feature that a user wishes to measure in using the method of the present invention. While the method is more advantageously used in large structures and large parts needing repair in those structures, it may be used to repair small structures and small portions as well, for instance, when such parts are out-of-stock or have very high prices. Accordingly, it is the intention of the applicants to protect all variations and modifications within the valid scope of the present invention. It is intended that the invention be defined by the following claims, including all equivalents.

What is claimed is:

1. A method for repairing a portion of a structure, comprising:
orienting a multi-axis digital measuring device;
measuring at least a portion of the structure with the device;
saving data generated in measuring the structure; and
using said data to automatically manufacture a repair part.

2. The method of claim 1, further comprising adding additional data for use in automatically manufacturing the repair part.

3. The method of claim 1, further comprising planning a process to manufacture the repair part.

4. The method of claim 1, further comprising installing the repair part.

5. The method of claim 1, further comprising orienting the device with respect to the structure via an orienting feature selected from the group consisting of plumb lines, orientation holes, a feature of the structure and a feature of the portion.

6. The method of claim 1, further comprising mounting a mounting bracket for the multi-axis device on the structure.

7. The method of claim 1, wherein automatically manufacturing comprises a multi-step process for material removal and material shaping.

8. The method of claim 1, further comprising transferring the repair part from a first workstation to a second workstation.

9. The method of claim 1, further comprising translating the data from a first format to a second format.

10. The method of claim 1, further comprising a data manipulation step selected from the group consisting of exporting data, importing data, verifying data, and transferring data.

11. The method of claim 1, further comprising mounting a laser-scanning device.

12. A method for repairing a sheetmetal portion of a structure, comprising:
orienting a multi-axis digital measuring device;
measuring at least a portion of the structure with the device;
saving data generated in measuring the structure; and
using said data to automatically manufacture a sheetmetal repair part.

13. The method of claim 12, further comprising adding additional data for use in automatically manufacturing the sheetmetal repair part.

14. The method of claim 12, further comprising planning a process to manufacture the repair part.

15. The method of claim 12, further comprising installing the repair part.

16. The method of claim 12, further comprising orienting the device with respect to the structure via an orienting feature selected from the group consisting of plumb lines, orientation holes, a feature of the structure and a feature of the portion.

17. The method of claim 12, further comprising mounting a mounting bracket for the multi-axis device on the structure.

18. The method of claim 12, wherein automatically manufacturing comprises a multi-step process for material removal and material shaping.

19. The method of claim 12, further comprising transferring the sheetmetal repair part from a first workstation to a second workstation.

20. The method of claim 12, further comprising a data manipulation step selected from the group consisting of exporting data, importing data, verifying data, and transferring data.

21. The method of claim 12, further comprising translating the data from a first format to a second format.

22. The method of claim 12, further comprising mounting a laser-scanning device.
